(19) United States
(12) Patent Application Publication
(10) Pub. No.: US 2014/0259928 A1
(43) Pub. Date: Sep. 18, 2014

(54) APPARATUS FOR REDUCING THE FORCE NECESSARY TO CLOSE A VEHICLE DOOR

(71) Applicant: Donald E. Morris, Kensington, CA (US)

(72) Inventor: Donald E. Morris, Kensington, CA (US)

(21) Appl. No.: 14/213,474

(22) Filed: Mar. 14, 2014

Related U.S. Application Data
(60) Provisional application No. 61/794,246, filed on Mar. 15, 2013.

(51) Int. Cl. E05F 15/20; E05F 5/06

(52) U.S. Cl. CPC E05F 15/20; E05F 15/2092; E05F 5/06
USPC 49/29; 49/70; 49/31; 49/506

(57) ABSTRACT

Apparatuses and methods are disclosed for reducing the force required to close a vehicle door. The apparatus may release trapped air in a vehicle to atmosphere, or may otherwise accommodate for a pressure spike in a vehicle as a closing door nears a fully closed position. The apparatus may be active or passive. The vehicle door may be any door on a vehicle, including a trunk door.

### RELATED APPLICATIONS

This application claims priority to the U.S. provisional patent application having Ser. No. 61/794,246, filed Mar. 15, 2013, which is incorporated by reference herein in its entirety.

### TECHNICAL FIELD

The disclosure herein relates generally to apparatuses and methods for reducing the force required to close a vehicle door.

### BACKGROUND

The force used to close a vehicle door may vary, depending upon environmental circumstances. For example, when only one door is open and all other doors and windows are closed, the force necessary to close a door is higher than when other doors or windows are open. Air in the vehicle becomes trapped as the door moves toward a closed position, suddenly increasing the air pressure in the interior of the vehicle when the door is nearly closed, impeding final closure. This effect tends to be more noticeable as a door approaches a fully closed position. This occurs because as the door nears the fully closed position, the gap between the door and vehicle frame become too small for air to easily escape. The same effect occurs when a door is fitted with two door seals since air may become trapped between them as a door nears a fully closed position. This increase in air pressure may cause a driver or a passenger to slam a door to ensure it is fully closed.

Apparatuses and methods are desired to release air which is trapped inside a vehicle during the final stages of closure in order to ease the effort necessary for the closing of vehicle doors, said release to be provided during the door closing interval without providing a large path between the interior and the exterior of the vehicle while driving. Apparatuses and methods are desired that provide additional advantages, such as protection from dust and other environmental particulates, fog, rain, snow, external noise, and wind noise by minimizing or preventing the ingress of outside air.

The disclosed apparatuses and methods may provide one or more such advantages.

### BRIEF DESCRIPTION OF THE DRAWINGS

Referring now to the drawings, illustrative embodiments are shown in detail. Although the drawings represent some embodiments, the drawings are not necessarily to scale and certain features may be exaggerated, removed, or partially sectioned to better illustrate and explain the present invention. Further, the embodiments set forth herein are exemplary and are not intended to be exhaustive or otherwise limit or restrict the claims to the precise forms and configurations shown in the drawings and disclosed in the following detailed description.

FIG. 1 is a vehicle with exemplary vehicle doors.

FIG. 2 is a schematic for an exemplary system for door closing.

FIG. 3 is an exemplary valve installed in a vehicle door.

FIG. 4 is an exemplary bag diaphragm installed in a vehicle door.

FIG. 5 is an exemplary bellows diaphragm installed in a vehicle door.

FIG. 6 is an exemplary valve with duct installed in a vehicle door.

FIG. 7 is an exemplary gasket valve installed on a vehicle door.

### DETAILED DESCRIPTION

FIG. 1 is a vehicle 10 with exemplary vehicle doors 12 and 14. Vehicle door 12 is intended for ingress and egress of riders and drivers, whereas vehicle door 14 is a trunk door. The vehicle 10 has windows 11, 13.

FIG. 2 is a schematic for a pressure relief apparatus for a vehicle 10. While three sensors 16, 17, and 18 are depicted for sensing conditions, more or fewer sensors are contemplated. Sensors or other mechanisms can be used to sense or detect or compute environmental conditions in, on or around vehicle 10. For example, one or more of sensors 16, 17, or 18 can detect a position of vehicle door 12, including whether the vehicle door 12 is open or closed, or how far the vehicle door 12 is from a fully closed or latched position. Sensors may include proximity switches that can indicate whether a vehicle door 12 is open or closed or undertaking an opening or closing movement. Proximity switches may use magnets and magnetic field sensors, and may also provide information relating to velocity of a vehicle door 12. Sensors may be sealed reed switches. Sensors can be placed on or around the vehicle door 12, or can be placed on or near a hinge of the vehicle door 12. One or more of sensors 16, 17 or 18 can detect or cause a calculation in a controller (also known as a control module) 20 to arrive at a vehicle door 12 velocity or acceleration. That is, the sensed input can be read from an accelerometer, for example. Controller 20 may optionally include computer readable storage media for storing data representing instructions executable by a computer or microprocessor. Computer readable storage media may include one or more of random access memory as well as various non-volatile memory such as read-only memory or keep-alive memory. Computer readable storage media may communicate with a microprocessor and input/output circuitry via a standard control/address bus. As appreciated by one of ordinary skill in the art, computer readable storage media may include various types of physical devices for temporary and/or persistent storage of data. Exemplary physical devices include but are not limited to DRAM, PROMS, EPROMS, EEPROMS, and flash memory.

One or more of sensors 16, 17 or 18 can detect or cause a calculation in a controller 20 to arrive at an air pressure reading of a vehicle 10 interior. For example, a pressure transducer may be used to monitor air pressure inside of vehicle 10. One or more of sensors 16, 17 or 18 can detect or cause a calculation in a controller 20 to arrive a distance between the sensor and a rider or driver's body or hand. Such a sensor may, for example, be placed on or near a handle of door. One or more of sensors 16, 17 or 18 can be a door switch, including a door switch operably connected with a dome light in a vehicle 10 interior. Such operable connection may be that the parts share common components, or that there are separate components in electrical communication with each other.

A manufacturer can establish one or more predetermined conditions under which input from one or more sensors 16, 17 or 18 will, at least in part, cause a controller 20 to send a signal to a mechanism 28 controlling one or more windows in a vehicle 10, causing the window to be lowered to relieve pressure to ease the closing movement of vehicle door 12. The mechanism 28 can be a motor or a device in communication with a motor driving window movement. For example, if it is sensed that a vehicle door 12 is beginning to close and an interior air pressure is above a threshold and a door velocity is below a threshold, the controller 20 may send a signal to the mechanism driving one or more windows 11, 13 to be lowered by a particular distance to relieve the excess pressure. If the controller 20 is also in electrical communication with a timing device 26, the timing device 26 may cause a second signal to return the one or more windows 11, 13 to their original position after a predetermined amount of time. The predetermined amount of time may be measured from the original signal to lower the windows 11, 13 or from sensed input that the vehicle door 12 is in a fully closed position. Other methods may be used to return windows 11, 13 to an initial position. For example, if a pressure transducer is a source of input causing the window 11, 13 to be lowered, directly or indirectly, then when interior air pressure returns to normal levels, a signal can be sent to return the windows 11, 13 to an initial position. In this example, the pressure transducer can vary a signal, depending on the air pressure to lower windows 11, 13 by a larger or smaller distance and/or for a longer or shorter time. In cases with a greater amount of trapped air, the window 11, 13 may be lowered a greater distance and/or for a longer time. In the alternative, the signal can be sent to one or more electrically controlled vent valves to allow the excess pressure to escape to the exterior.

Generally, it is contemplated that any sensors 16, 17 or 18 may be placed on, at or near a vehicle door 12. Near, for example, may be within 50 cm of a physical location where a pressure spike may be expected to be experienced, such as a door gasket. Closer distances are also contemplated, such as within 15 cm or within 5 cm. This may be the case in circumstances where pressure change is a predetermined factor to determine whether to lower one or more windows 11, 13.

When pressure sensors and/or accelerometers are used in connection with an exemplary apparatus, additional advantages may be realized. For example, it may not be necessary to sense relative motion of a vehicle door 12 as against a vehicle 10. So, pressure sensors and/or accelerometers may be attached to or integrated with a motor that drives window 11, 13. A controller 20 may optionally be integrated with pressure sensors and/or accelerometers to simplify an assembly process. In the case of an accelerometer, the acceleration of the vehicle door 12 is zero when the vehicle 10 is stationary, except when opening and closing the vehicle door 12. This means output from one or more accelerometers can be integrated to determine velocity and position information during opening and closing movements of vehicle door 12. The baseline of where the vehicle door 12 is closed and stationary could be determined by any of a number of methods. One such method is the determination of whether vehicle door 12 acceleration is zero for a predetermined amount of time. Other such methods include noting when a vehicle door 12 begins to move outward or inward with an accelerometer or door switch or proximity switch.

Other exemplary designs of apparatuses are contemplated to reduce the force required to complete a closing movement of a vehicle door 12 by releasing the excess interior pressure just before the moment of closure. Certain examples may include mechanical (non-electrical) apparatuses to accomplish pressure relief functions. Referring to FIG. 3, a cross-section of a vehicle door 12 with window 34 and top frame 35 is shown. A valve 30 is also shown in situ. In one instance, a valve 30 could be provided that is in communication with the interior of vehicle 10 as well as the atmosphere. Such a valve 30 may be a reasonably large diameter substantially one-way poppet valve or a flap valve. The valve may have a return spring 31 that is strong enough to close the valve when there is no pressure difference between the vehicle interior and exterior, yet weak enough to allow the valve to open to release the overpressure produced in the vehicle interior when the door is closing and nearing a fully closed position. In this example, the valve with return spring mechanically performs the function of a pressure sensor and transducer in an electrical system. When the pressure difference between the inside and outside exceeds a prescribed value, it overcomes the return spring and opens the relief valve mechanically, instead of electrically. A poppet valve has a moving plug that is kept in place by a resilient force (for example, a spring or elastic member or a weight) that can be overcome when a certain threshold of pressure is reached. A flap valve is essentially a one-way valve with a rigid or flexible moving plate or plug covering an opening in a vehicle door 12 and hinged outside of but relatively near an edge of said opening. In one implementation, the flap valve is provided with a mass positioned on the other side of the hinge and attached to the moving plate by an extension arm. The mass acts as an accelerometer would in an electrical system. When the rapidly closing door decelerates, the inertia of the mass causes it to continue moving toward the interior of the vehicle, causing the attached valve plate assembly to rotate on the hinge, overcoming the resistance of the return spring and moving the plate outward to open the valve mechanically, instead of electrically.

The cross-section of the openings from the interior 32, the valve 30, and the opening to the exterior 33 each need to be large enough to allow the air displaced by the closing door to escape to the interior of the door or outside. A threshold may be set so an initial slow rise in air pressure in an interior as a vehicle door 12 begins to close takes place without opening the valve 30, but then as the interior air pressure rises when the vehicle door 12 approaches a fully closed position, the valve 30 opens. This opening allows ventilation and eases the effort to close the vehicle door 12. This threshold before opening may also minimize air displacement through valve 30. Such a valve 30 may permit air to escape a vehicle interior or a trunk, or from a vehicle interior to a trunk, upon reaching a predetermined pressure differential between the interior of vehicle 10 and the atmosphere. Such a valve 30 may optionally include a definite closing structure 31. That is, structure to keep valve 30 closed after its release. Such structure may offer advantages such as protection from dust, other environmental particulates, external noise and/or wind noise.

Referring now to FIG. 4 and FIG. 5, both of which show a cross-section of a vehicle door 12, another contemplated exemplary apparatus is illustrated. FIG. 4 involves a diaphragm in the form of a bag 40 covering an opening between an interior of a vehicle 10 and the atmosphere. FIG. 5 involves a diaphragm in the form of a bellows 50 covering an opening between an interior of a vehicle 10 and the atmosphere. In both cases, the diaphragm or bellows mechanically performs both functions of detection of a pressure rise and movement to relieve excess pressure. Other types of diaphragms other than bags and bellows may be suitable for use with the presently disclosed apparatuses and methods.

It is contemplated that a diaphragm could also cover an opening between an interior of a trunk of a vehicle 10 and the atmosphere. The diaphragm may be flexible or resilient, and may be formed at least in part of a natural or synthetic rubber, cloth or a plastic. The diaphragm may be fixed over the opening, and it may expand or contract according to changing pressure conditions. The diaphragm may take many forms, including the form of bag 40 that inflates to an inflated shape 41 or deflates to a deflated shape 42, or bellows 50 that opens to an open position 51 or closes to a closed position 52 according to changing pressure conditions. Such a diaphragm may be sufficient to absorb pressure spikes and may obviate the need for release of trapped air to atmosphere. Such a diaphragm may offer additional advantages, such as protection from dust, other environmental particulates, external noise and wind noise.

Exemplary apparatuses may be placed in many locations on a vehicle 10. For example, the diaphragm containing apparatus could reside in an opening between the inside face of the vehicle door 12 and one or more openings on the edge of the door outside of a door seal. For protection, the diaphragm may optionally be covered with a grill or a screen on the inside 32 and/or on the outside 33. Additionally, a diaphragm may be placed between the interior of the vehicle 10 and the trunk 14 to absorb the final pressure spike from a closing vehicle door 12. A pressure relief system could also be placed between the body of the vehicle 10 and the trunk 14.

Placement of an exemplary apparatus may be optimized considering the speed of sound. Without being limited by theory, this may be because pressure peaks addressed herein are relatively small compared to atmospheric pressure, and so such pressure peaks travel at the speed of sound. That is, the speed of sound may limit the distance from the vehicle door 12 for an apparatus to be effective. In a prophetic example, a speed of a closing movement is 24 inches per second. In the same prophetic example, an interior air pressure peak occurs when the distance of the vehicle door 12 (at its furthest point from a hinge) is less than ¼ inch from a fully closed position. Then, in such case duration of a pressure peak pulse would be about 0.01 seconds. For the pressure pulse peak to be reduced, an exemplary apparatus would be placed close enough to the vehicle door 12 to relieve the pressure in a small fraction of the 0.01 pulse duration. If placed farther from the vehicle door 12, the exemplary apparatus would have to provide larger cross section to relieve the pressure pulse.

Other factors may be considered for optimizing an exemplary apparatus, including the nature of a pressure pulse. The pressure pulses described herein may be likened to a drum, on which a strike causes a positive pressure pulse followed by a negative pressure pulse. The negative pressure pulse may be accounted for in a valve 30 structure to pull a vehicle door 12 tight. The momentum of the air escaping through an exemplary apparatus with a one way valve would enhance the negative pressure pulse.

Referring now to FIG. 6, which shows a cross-section of a vehicle door 12, a duct 66 through which the air flows out of the vehicle 10 may enhance the negative pressure pulse, especially when a duct has an optimal cross-section and length. A longer duct may enhance the momentum of the air passing through the said duct 66 and thereby increase the following negative pressure pulse. Too long or too small of a cross-section on a duct 66 may sustain excessive positive pressure within the interior of vehicle 10 and may then interfere with easy closure of a vehicle door 12.

Referring now to FIG. 7, which shows the cross-section through the edge of the vehicle door 70 and the adjacent door jamb 71, a vehicle door gasket 72 which itself may include structure for venting or absorbing pressure spikes. The gasket 72 may act as a flap valve, allowing air to escape outward when internal pressure is higher but closing to a closed position 74 to provide a seal at other times. In FIG. 7, the exemplary gasket 72 is shown directed outward 73 toward the exterior from its anchored edge on the bottom of the door so that when the interior pressure is higher it would push the seal outward 73 and away from the door jamb 71, opening a passage for escape of the interior excess pressure. Placement of the venting gasket along the bottom of the door may have the added advantage that a path for the air from the gasket/vent to the outside could be provided by a gap between the inside of the vehicle door and the vehicle frame which would be less visible.

Other gasket designs that accomplish the same result are contemplated. The venting gasket could be placed near the hinged edge of the vehicle door so that the vehicle door would provide more direct compression and less sliding of the gasket along the surface of the door jamb during door closing. In such case, the air could vent into the front quarter panel. Alternatively, the venting gasket could be placed on the vehicle door edge opposite the hinged edge so that the vehicle door would provide less direct compression and more sliding of the gasket along the surface of the door jamb.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

1. A pressure relief apparatus for a vehicle door, comprising:
a mechanism operably affiliated with the vehicle door, such that the mechanism is adapted to relieve excess pressure that is generated during door closure.

2. The pressure relief apparatus of claim 1, wherein the mechanism comprises
a sensing mechanism for determining whether one or more predetermined conditions in a vehicle are satisfied when a vehicle door is open; and
a controller in electrical communication with the sensing mechanism and with at least one vehicle window or vent, such that when predetermined conditions are met, the controller sends a signal to cause lowering of at least one vehicle window or opening of at least one vent.

3. The pressure relief apparatus of claim 2, wherein the sensing mechanism is a sensor adapted to determine vehicle door position.

4. The pressure relief apparatus of claim 2, wherein the sensing mechanism is a door switch that indicates whether a vehicle door is open or closed.

5. The pressure relief apparatus of claim 4, wherein the door switch is further in electrical communication with a vehicle dome light.

6. The pressure relief apparatus of claim 4, further comprising a timing device in electrical communication with the controller, whereby after an open vehicle door is closed, after a predetermined time, the controller is adapted to send a signal to cause raising of the at least one vehicle window or closing of at least one vent to its initial position.

7. The pressure relief apparatus of claim 2, wherein the sensing mechanism is a sensor adapted to determine a position of a hand or body from a door handle.

8. The pressure relief apparatus of claim 2, wherein the sensing mechanism is one or more of a position detector, a velocity detector, an accelerometer and a pressure transducer.

9. The pressure relief apparatus of claim 2, wherein the sensing mechanism is a pressure transducer and its signal determines one or more of the timing and distance of the window lowering and the time at which the window is raised to an initial position.

10. The pressure relief apparatus of claim 2, wherein the predetermined conditions include at least one of door position, door velocity, door acceleration, and air pressure inside a vehicle.

11. The pressure relief apparatus of claim 1, wherein the mechanism comprises
a valve in mechanical communication between a vehicle interior and exterior, the valve being adapted to release air form the vehicle interior during a closing movement of a vehicle door.

12. The pressure relief apparatus of claim 11 wherein the valve is a poppet valve.

13. The pressure relief apparatus of claim 11 wherein the valve is a flap valve.

14. The pressure relief apparatus of claim 11 wherein the valve has closing structure comprising a resilient member.

15. The pressure relief apparatus of claim 11 wherein the valve has closing structure which uses gravity for closing action.

16. The pressure relief apparatus of claim 11 wherein the vehicle door is a trunk door.

17. The pressure relief apparatus of claim 1, comprising:
a resilient diaphragm separating a vehicle interior from external environment, the diaphragm being adapted to absorb pressure spikes during a vehicle door closing movement.

18. The pressure relief apparatus of claim 17, wherein the diaphragm comprises a bellows.

19. The pressure relief apparatus of claim 17 wherein the diaphragm comprises a bag formed at least in part from a plastic, natural or synthetic cloth, or natural or synthetic rubber.

20. A method for reducing the force required to close a door, comprising:
sensing whether a vehicle door is being closed; and
releasing air from a vehicle interior to atmosphere or absorbing excess interior air pressure with a diaphragm.
